(19) United States
(12) Patent Application Publication
(10) Pub. No.: US 2025/0306577 A1
(43) Pub. Date: Oct. 2, 2025

(54) SYSTEMS AND METHODS FOR MODELLING ASSETS IN A FACILITY

(71) Applicant: Honeywell International Inc., Charlotte, NC (US)

(72) Inventors: Jayaprakash Meruva, Bangalore (IN); Venugopala Nadumane, Bangalore (IN); Vijay Raju, Bengaluru (IN)

(21) Appl. No.: 18/669,549

(22) Filed: May 21, 2024

(30) Foreign Application Priority Data
Mar. 26, 2024 (IN) 202411023801

(51) Int. Cl. G05B 19/418

(52) U.S. Cl. CPC G05B 19/41885; G05B 19/4187; G05B 2219/13144

(57) ABSTRACT

Various embodiments described herein relate to systems and methods for modelling assets in a facility. In this regard, data associated with the assets in the facility is initially received from the assets. Also, one or more data models associated with the assets is then retrieved. The data is then contextualized based at least on the one or more data models. Based at least on the contextualized data, an asset model for at least one asset is generated. Further, the one or more data models are also updated with the generated asset model. Additionally, one or more dashboards are also generated based on the one or more updated data models. Also, one or more operations associated with the assets are controlled based at least on the one or more updated data models as well.

### TECHNICAL FIELD

The present disclosure generally relates to a building management system. More particularly, the present disclosure relates to modelling one or more assets using data associated with the one or more assets in a facility.

### BACKGROUND

Generally, a facility (such as a building, a warehouse, an industrial plant, an airport, and/or the like) includes numerous assets or equipment such as boilers, chillers, air handling units (AHUs), variable refrigerant flow (VRF) systems, pumps, and/or the like. Further, each of these assets is associated with several sensors as well. At times, users rely on Building Management System (BMS) to control operations in facilities. For the BMS to control operations in the facility, assets in the facility needs to be modelled in the BMS. Currently, facilities rely on domain knowledge of workers such as facility managers or site engineers to manually model such assets in the BMS and to configure dashboards. In this regard, the workers create asset models, assign points and point roles for sensors, and configure relevant dashboards. Such manual work is a cumbersome task as the workers spend substantial amount of time to model numerous assets and configure several dashboards. This often results in unoptimized management of the facility and/or utilization of both electronic and human resources of the facility. Also, at times, manual modelling of assets is error prone as it is likely that the workers may, for instance, assign wrong points and point roles for sensors, model a wrong equipment, and/or the like due to huge number of assets in the facility. In this regard, one or more incorrect actions may be undertaken in the facility to control the operations. Accordingly, modelling assets and configuring dashboards in the facility becomes challenging.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 illustrates a schematic diagram showing an exemplary environment comprising multiple facilities, in accordance with one or more example embodiments described herein.

FIG. 2 illustrates a schematic diagram showing an exemplary facility, in accordance with one or more example embodiments described herein.

FIG. 3 illustrates a schematic diagram showing an implementation of a controller that may execute techniques in accordance with one or more example embodiments described herein.

FIG. 4 illustrates a schematic diagram showing an implementation of an exemplary asset modelling system, in accordance with one or more example embodiments described herein.

FIGS. 5A-5D illustrate schematic diagrams showing exemplary user interfaces associated with an exemplary asset modelling system, in accordance with one or more example embodiments described herein.

FIG. 6 illustrates a flowchart showing a method described in accordance with one or more example embodiments described herein.

FIG. 7 illustrates a flowchart showing a method described in accordance with one or more example embodiments described herein.

FIG. 8 illustrates a flowchart showing a method described in accordance with one or more example embodiments described herein.

FIG. 9 illustrates a flowchart showing a method described in accordance with one or more example embodiments described herein.

FIG. 10 illustrates a flowchart showing a method described in accordance with one or more example embodiments described herein.

FIG. 11 illustrates a flowchart showing a method described in accordance with one or more example embodiments described herein.

FIG. 12 illustrates a flowchart showing a method described in accordance with one or more example embodiments described herein.

### SUMMARY

The details of some embodiments of the subject matter described in this specification are set forth in the accompanying drawings and the description below. Other features, aspects, and advantages of the subject matter will become apparent from the description, the drawings, and the claims.

In accordance with one or more example embodiments of the current disclosure, a method for modelling one or more assets in a facility is described herein. In this regard, the method comprises receiving data associated with the one or more assets in the facility. The method also comprises retrieving one or more data models associated with the one or more assets. Then, the method comprises contextualizing the data based at least on the one or more data models. Further, the method comprises generating an asset model for at least one asset of the one or more assets based at least on the contextualized data. Furthermore, the method comprises updating the one or more data models with the asset model. Additionally, the method comprises generating one or more dashboards based on the one or more updated data models. The method also comprises controlling one or more operations associated with the one or more assets based at least on the one or more updated data models.

In accordance with another embodiment of the current disclosure, a system for modelling one or more assets in a facility is described herein. The system comprises a processor and a memory communicatively coupled to the processor, wherein the memory comprises one or more instructions which when executed by the processor, cause the processor to receive data associated with the one or more assets in the facility. The processor is also configured to retrieve one or more data models associated with the one or more assets. Further, the processor is configured to contextualize the data based at least on the one or more data models. Furthermore, the processor is configured to generate an asset model for at least one asset of the one or more assets based at least on the contextualized data. Then, the processor is configured to update the one or more data models with the asset model. Additionally, the processor is configured to generate one or more dashboards based on the one or more updated data models. Also, the processor is configured to control one or more operations associated with the one or more assets based at least on the one or more updated data models.

In accordance with yet another embodiment of the current disclosure, a non-transitory, computer-readable storage medium having instructions stored thereon and executable by one or more processors is described herein. In this regard, the instructions when executed by one or more processors cause the one or more processors to receive data associated with one or more assets in a facility. The one or more processors are also configured to retrieve one or more data models associated with the one or more assets. Further, the one or more processors are configured to contextualize the data based at least on the one or more data models. Furthermore, the one or more processors are configured to generate an asset model for at least one asset of the one or more assets based at least on the contextualized data. Then, the one or more processors are configured to update the one or more data models with the asset model. Additionally, the one or more processors are configured to generate one or more dashboards based on the one or more updated data models. Also, the one or more processors are configured to control one or more operations associated with the one or more assets based at least on the one or more updated data models.

The above summary is provided merely for purposes of providing an overview of one or more exemplary embodiments described herein so as to provide a basic understanding of some aspects of the disclosure. Accordingly, it will be appreciated that the above-described embodiments are merely examples and should not be construed to narrow the scope or spirit of the disclosure in any way. It will be appreciated that the scope of the disclosure encompasses many potential embodiments in addition to those here summarized, some of which are further explained in the following description and its accompanying drawings.

Additional objects and advantages of the disclosed embodiments will be set forth in part in the description that follows, and in part will be apparent from the description, or may be learned by practice of the disclosed embodiments. The objects and advantages of the disclosed embodiments will be realized and attained by means of the elements and combinations particularly pointed out in the appended claims.

It is to be understood that both the foregoing general description and the following detailed description are exemplary and explanatory only and are not restrictive of the disclosed embodiments, as claimed.

### DETAILED DESCRIPTION OF THE DRAWINGS

Reference will now be made in detail to embodiments, examples of which are illustrated in the accompanying drawings. In the following detailed description, numerous specific details are set forth in order to provide a thorough understanding of the various described example embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments. The term “or” is used herein in both the alternative and conjunctive sense, unless otherwise indicated. The terms “illustrative,” “example,” and “exemplary” are used to be examples with no indication of quality level. Like numbers refer to like elements throughout.

The phrases “in an embodiment,” “in one embodiment,” “according to one embodiment,” and the like generally mean that the particular feature, structure, or characteristic following the phrase can be included in at least one example embodiment of the present disclosure, and can be included in more than one example embodiment of the present disclosure (importantly, such phrases do not necessarily refer to the same example embodiment).

The word “exemplary” is used herein to mean “serving as an example, instance, or illustration.” Any implementation described herein as “exemplary” is not necessarily to be construed as preferred or advantageous over other implementations. If the specification states a component or feature “can,” “may,” “could,” “should,” “would,” “preferably,” “possibly,” “typically,” “optionally,” “for example,” “often,” or “might” (or other such language) be included or have a characteristic, that particular component or feature is not required to be included or to have the characteristic. Such component or feature can be optionally included in some example embodiments, or it can be excluded.

One or more example embodiments of the present disclosure may provide an “Internet-of-Things” or “IoT” platform in a facility that uses real-time accurate models and visual analytics to model one or more assets in the facility. The IOT platform is an extensible platform that is portable for deployment in any cloud or data center environment for providing an enterprise-wide, top to bottom view, displaying status of processes, assets, people, and/or safety. Further, the IOT platform of the present disclosure supports end-to-end capability to execute digital twins against data associated with the assets to provide appropriate analyses and/or predictions related to the one or more assets in the facility.

Often, facilities include innumerable assets or equipment to facilitate various operations. For example, a facility may include several assets such as boilers to supply hot water, air handling units (AHUs) to regulate and circulate air, pumps to push and circulate fluids, chillers to maintain temperature at a constant level, industrial lighting to provide appropriate illumination, and/or the like. Commonly, the facilities rely on Building Management System (BMS) to manage such assets. For the BMS to manage the assets and control operations, the BMS needs to have appropriate information related to all assets. The facilities further rely on operators with sufficient domain knowledge to provide all appropriate information to the BMS and configure relevant dashboards for viewing. Said alternatively, operators with sufficient domain knowledge manually model all the assets in the BMS and determine what has to be rendered as dashboards. However, this has several shortcomings and associated challenges. Firstly, the operators spend substantial time to manually model numerous assets, and this becomes a cumbersome task. Also, while onboarding new assets, most of the time is spent on manual modelling and dashboard configuration for the new assets resulting in delayed onboarding. Secondly, each of the assets may be further associated with several sensors which needs to be modelled as well. In this regard, the operators need to manually map all the sensors and their associated points to respective assets. While providing such granular level of details, it is likely that the operators may commit errors i.e., the operators may, for instance, assign wrong points and point roles for sensors, model a wrong equipment, and/or the like. Accordingly, the operators may fail to scale up to the huge number of assets in order to accurately provide the required information. This often results in unoptimized utilization of both electronic and human resources of the facilities. At times, due to error in modelling, one or more incorrect actions may be undertaken by the BMS too. Also, impertinent or irrelevant information related to the assets may be rendered as dashboards well.

Thus, to address the above challenges, various examples of systems and methods described herein facilitate automatic modelling of one or more assets in a facility. In this regard, for instance, an example system described herein initially receives data associated with the one or more assets in the facility. For example, the system receives data associated with assets such as boilers, chillers, air handling units (AHUs), variable refrigerant flow (VRF) systems, pumps, and/or the like which are spread across different locations within the facility. Then, the system pre-processes the data to be compatible for transmission to say, a cloud supervisor platform or a remote building manager platform from the assets. Further, the system is configured to retrieve one or more data models associated with the one or more assets. For example, the cloud supervisor platform or a remote building manager platform may already have one or more data models i.e., extensible object models (EOMs) models which describe assets (e.g., as nodes) of the facility and relationship of the assets with other components/assets (e.g., the links). Also, the models may describe type of sensors mounted on any given asset and type of data that is being sensed by each sensor. Then, if an asset is newly onboarded or if an asset is to be newly modelled or if details of an asset are absent in the data models, the system described herein automatically generates one or more asset models for the required asset(s). In some instances, the system may generate the asset models based on a request received from a user such as, facility manager or site engineer in the facility. In this regard, the system initially contextualizes data received from the assets based at least on the one or more data models. For instance, the system analyzes context such as, but not limited to a location of an asset in the facility, a type of parameter measured by the asset, other related assets or equipment in the facility, role of parameter associated with the asset, and/or the like with regards to contextualization of the data. Accordingly, the system then generates the one or more asset models for required asset(s) based at least on the contextualized data. Per this aspect, the system identifies a name of an asset, determines one or more devices associated with the asset, assigns one or more points for the asset, assigns one or more role of points for the asset, schedule of operation for the asset, and/or the like from the contextualized data to automatically generate the asset model for the asset. Upon generation of such asset models, the system updates the existing one or more data models with the one or more asset models.

Further, the system also automatically generates one or more dashboards based on the one or more updated data models. In this regard, the one or more dashboards comprise one or more details such as name of assets or equipment, one or more devices associated with the assets, one or more points associated with the assets, one or more points roles of the assets, and/or the like. Also, the system via a user interface renders the one or more dashboards associated with the one or more assets in the facility. The system also allows the user in the facility to modify one or more fields in the dashboard(s), if required i.e., the system allows the user to customize the one or more dashboards. For example, if the user wants to additionally assign a point role for an asset, then the user can perform corresponding modifications in an appropriate dashboard. In another example, the user via an appropriate dashboard can also set schedules at which an asset is to be operated for the assigned point and point role. Yet in another example, the user can modify one or more fields in an appropriate dashboard to view only certain details associated with the assets. Also, the system learns the usage patterns related to the dashboard(s) to render the most appropriate dashboard to the user. At times, the system also updates the one or more data models based at least on the modifications done by the user in an appropriate dashboard. Also, the system utilizes at least the one or more updated data models to control one or more operations associated with the one or more assets in the facility as well.

Accordingly, various embodiments of the systems and methods described herein facilitate automatic generation of asset model(s) and configurable dashboards for the one or more assets in the facility. With this, reliance on operators or workers such as facility managers or site engineers to manually model assets and to configure dashboards is eliminated. With this, optimized management of the facility and/or effective utilization of both electronic and human resources of the facility is achieved. Additionally, the asset model(s) and the dashboards generated herein unlock various insights related to the one or more assets such as optimal operation points, interrelationship between the assets, and/or the like that facilitate optimal control of one or more operations in the facility.

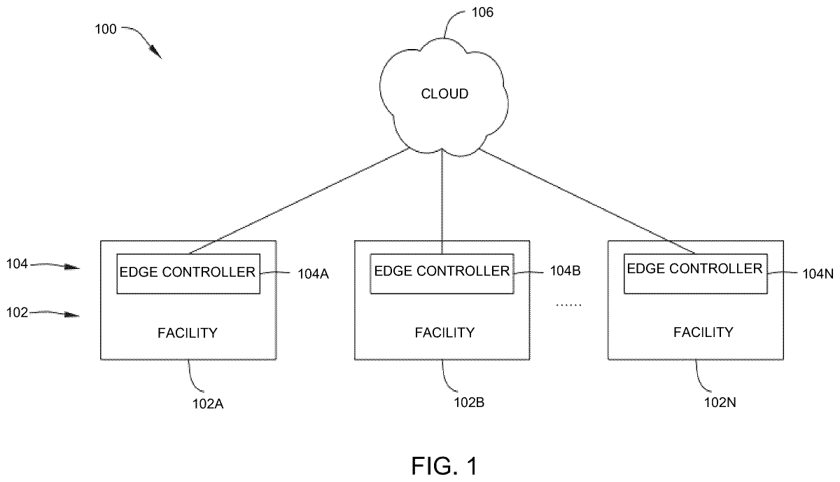

FIG. 1 illustrates a schematic diagram showing an exemplary environment comprising multiple facilities. According to various example embodiments described herein, an exemplary environment 100 comprises one or more facilities 102a, 102b, . . . 102n (collectively “facilities 102”). In some example embodiments, a facility of the one or more facilities 102a, 102b, . . . 102n may correspond to, for example, a commercial building, an institutional building, a factory, an industry, an IT park, a corporate office, a logistics environment, an airport premises, a transportation hub, a material handling environment, a warehouse, a supply chain environment, a data center, an industrial plant, and/or the like. In some example embodiments, the one or more facilities 102a, 102b, . . . 102n in the illustrative environment 100 may be of same type. In some example embodiments, the one or more facilities 102a, 102b, . . . 102n in the illustrative environment 100 may be of different type. As it may be understood, in some example embodiments described herein, the facilities 102 often include one or more assets that facilitate numerous operations in the facilities 102. For example, a facility may include several assets such as boilers, air handling units (AHUs), pumps, chillers, industrial lighting, and/or the like to facilitate several operations in the facility. At times, the facilities 102 may incorporate one or more building management systems (BMS) or building supervisor platforms to manage the assets and/or the operations in the facilities 102. In this regard, the BMS needs to have all details associated with the assets and/or the operations in the facilities 102 in order to manage the facilities 102. That is, for the BMS to efficiently manage the facilities 102, the BMS needs to have appropriate models that provide relevant information associated with the assets and/or the operations in the facilities 102.

In some example embodiments, a cloud 106 is operably coupled with one or more facilities 102a, 102b, . . . 102n, meaning that communication between the cloud 106 and one or more facilities 102a, 102b, . . . 102n is enabled. The cloud 106 may represent distributed computing resources, software, platform or infrastructure services which can enable data handling, data processing, data management, and/or analytical operations on the data exchanged & transacted amongst various assets of the facilities 102. In this regard, in some example embodiments described herein, the cloud 106 represents the BMS or building supervisor platform that comprises one or more services to manage the facilities 102. In accordance with some example embodiments, data associated with the one or more assets such as telemetry data (e.g. sensor data from one or more sensors associated with the assets) and model data (e.g. contextual information and/or one or more models associated with the assets) can be uploaded to the cloud 106 for processing. In this regard, in some examples, the model data may correspond to JSON and/or XML files. In some example embodiments, the data may be associated with one or more operations of the assets situated in the one or more facilities 102a, 102b, . . . 102n. In some examples, the cloud 106 may receive and/or transact operational data (OT data) and information technology (IT) enabled data through the facilities 102. In some examples, the OT data may represent telemetry data. Telemetry data can include time stamps and data values corresponding to those time stamps. In other words, telemetry data can represent data collected over a period of time (e.g. continuous data stream captured over a time period) from various assets (e.g. sensors, IOT network) of the facilities 102. Whereas in some examples, the model data can comprise hierarchical relations of the one or more assets in the facilities 102. In some example embodiments described herein, the one or more services of the cloud 106 facilitate generation of one or more models for the assets in the facilities 102 based at least on processing and modelling of the data associated with the assets. In this regard, the cloud 106 utilizes the one or more models to manage the facilities 102.

In some example embodiments, the cloud 106 includes one or more servers that may be programmed to communicate with the one or more facilities 102a, 102b, . . . 102n and to exchange data as appropriate. The cloud 106 may be a single computer server or may include a plurality of computer servers. In some example embodiments, the cloud 106 may represent a hierarchal arrangement of two or more computer servers, where perhaps a lower level computer server (or servers) processes the data, for example, while a higher-level computer server oversees operation of the lower level computer server or servers.

The one or more facilities 102a, 102b, . . . 102n may include a variety of different assets. In some example embodiments, the one or more facilities 102a, 102b, . . . 102n may include a variety of different assets, at least some of which are of same type. In some example embodiments, the one or more facilities 102a, 102b, . . . 102n may include a variety of different assets, at least some of which are of different type. In the example shown in FIG. 1, each of the one or more facilities 102a, 102b, . . . 102n includes a respective edge controller 104a, 104b, . . . 104n (collectively “edge controllers 104”). In some example embodiments, each of one or more edge controllers 104a, 104b, . . . 104n is configured to receive data from a variety of assets or their associated sensors within the one or more facilities 102a, 102b, . . . 102n. In some examples, the one or more edge controllers 104a, 104b, . . . 104n may operate as intermediary node to transact data through one or more assets of the facilities 102 and/or to the cloud 106. In some examples, each of the one or more edge controllers 104a, 104b, . . . 104n is capable of receiving the data from disparate data sources e.g., but not limited to, in different data formats and/or using various data communication protocols, from assets of the facilities 102. In this regard, each of the one or more edge controllers 104a, 104b, . . . 104n can receive & filter the data and translate the data into a common language and/or format (e.g. normalized data) for subsequent communication to the cloud 106. The common language and/or format may be compatible with and expected by the cloud 106.

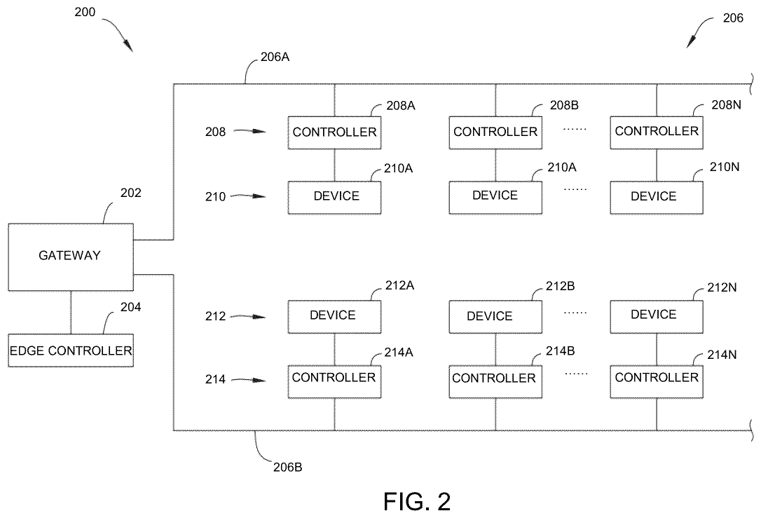

FIG. 2 illustrates a schematic diagram showing an exemplary facility. In various example embodiments, an example facility 200 of FIG. 2 comprises assets communicatively coupled via multiple networks 206 (e.g. communication channels). For instance, as illustrated in FIG. 2, the facility 200 may include a first network 206a and a second network 206b. In an example embodiment, the facility 200 may include only a single network 206. Whereas in another example embodiment, the facility 200 may include multiple networks 206. Each of the networks 206 may include any available network infrastructure. In an example embodiment, each of the networks 206 may independently be, for example, a BACnet network, a NIAGARA network, a NIAGARA CLOUD network, or others. Accordingly, in some example embodiments, the facility 200 may comprise a plurality of assets and/or devices in communication with a gateway 202 via corresponding communication channel (e.g. networks 206a and/or 206b). Said differently, each of the network may represent a sub-network supported by an underlined network communication/IoT protocol and incorporating a cluster of end-points (e.g. assets, controllers etc. in building facility).

In an example embodiment, one or more first devices 210a, 210b, . . . 210n (collectively “first devices 210”, alternatively “first assets 210”) are operably coupled to the first network 206a via one or more first controllers 208a, 208b, . . . 208n (collectively “first controllers 208”). The one or more first devices 210a, 210b, . . . 210n may represent a variety of different types of assets that may be found within the facility 200. For example, the one or more first devices 210a, 210b, . . . 210n may correspond to devices or assets within a factory or an industrial process. In this regard, the one or more first devices 210a, 210b, . . . 210n can be, but not limited to boilers, chillers, air handling units (AHUs), variable refrigerant flow (VRF) systems, pumps, lighting, and/or the like. Also, the one or more first devices 210a, 210b, . . . 210n facilitate one or more operations in the facility 200. For example, there can be boilers to supply hot water, air handling units (AHUs) to regulate and circulate air, pumps to push and circulate fluids, chillers to maintain temperature at a constant level, industrial lighting to provide appropriate illumination, and/or the like.

In some example embodiments, the one or more first controllers 208a, 208b, . . . 208n control operation of at least one of the one or more first devices 210a, 210b, . . . 210n. In some example embodiments, the one or more first controllers 208a, 208b, . . . 208n can transact data that can be processed and/or analyzed to generate one or more asset models for the one or more first devices 210a, 210b, . . . 210n. Also, in some example embodiments, the one or more first controllers 208a, 208b, . . . 208n may be built into one or more of the corresponding one or more first devices 210a, 210b, . . . 210n, and may not be a separate component. Whereas in other example embodiments, the one or more first controllers 208a, 208b, . . . 208n may be virtual controllers that may be implemented within a virtual environment hosted by one or more computing devices (not illustrated). The one or more first controllers 208a, 208b, . . . 208n may be containerized. Also, in some example embodiments, at least some of the one or more first devices 210a, 210b, . . . 210n may be controllers. In such case, the one or more first devices 210a, 210b, . . . 210n may not have a separate corresponding controller of the one or more first controllers 208a, 208b, . . . 208n.

In an example embodiment, one or more second devices 212a, 212b, . . . 212n (collectively “second devices 212”, alternatively “second assets 212”), are operably coupled to the second network 206b via one or more second controllers 214a, 214b, . . . 214n (collectively “second controllers 214”). The one or more second devices 212a, 212b, . . . 212n may represent any of a variety of different types of assets that may be found within the facility 200. For example, the one or more second devices 212a, 212b, . . . 212n may correspond to devices or assets within a factory or an industrial process. In this regard, the one or more second devices 212a, 212b, . . . 212n can be, but not limited to boilers, chillers, air handling units (AHUs), variable refrigerant flow (VRF) systems, pumps, lighting, and/or the like. Also, the one or more second devices 212a, 212b, . . . 212n facilitate one or more operations in the facility 200. For example, there can be boilers to supply hot water, air handling units (AHUs) to regulate and circulate air, pumps to push and circulate fluids, chillers to maintain temperature at a constant level, industrial lighting to provide appropriate illumination, and/or the like.

In some example embodiments, the one or more second controllers 214a, 214b, . . . 214n control operation of at least one of the one or more second devices 212a, 212b, . . . 212n. In some example embodiments, the one or more second controllers 214a, 214b, . . . 214n can transact data that can be processed and/or analyzed to generate one or more asset models for the one or more second devices 212a, 212b, . . . 212n. Also, in some example embodiments, the one or more second controllers 214a, 214b, . . . 214n may be built into one or more of the corresponding one or more second devices 212a, 212b, . . . 212n, and may not be a separate component. Whereas in other example embodiments, the one or more second controllers 214a, 214b, . . . 214n may be virtual controllers that may be implemented within a virtual environment hosted by one or more computing devices (not illustrated). The one or more second controllers 214a, 214b, . . . 214n may be containerized. Also, in some example embodiments, at least some of the one or more second devices 212a, 212b, . . . 212n may be controllers. In such case, the one or more second devices 212a, 212b, . . . 212n may not have a separate corresponding controller of the one or more one or more second controllers 214a, 214b, . . . 214n.

In an example embodiment, the facility 200 may include a gateway 202 that is operably coupled with the first network 206a and the second network 206b. In one example embodiment, the gateway 202 may be operably coupled with the first network 206a but not with the second network 206b. In another example embodiment, the gateway 202 may be operably coupled with the second network 206b but not with the first network 206a. In an example embodiment, the gateway 202 may be a legacy controller. In another example embodiment, the gateway 202 may be absent as well.

In an example embodiment, an edge controller 204 is installed within the facility 200. In some example embodiments, the edge controller 204 may be operably coupled with the gateway 202. The edge controller 204 may be considered as functioning as an intermediary between the first controllers 208, the second controllers 214, and the cloud 106. For instance, in an example, the edge controller 204 can pull data from the first controllers 208 and the second controllers 214 and provide the data to the cloud 106. In an example embodiment, the edge controller 204 is configured to discover the first devices 210, the second devices 212, the first controllers 208, and/or the second controllers 214 that are connected along a local network such as the network 206. In an example embodiment, the network protocol of the network 206 includes discovery commands that, for example, are used to request that all devices connected to the network 206 identify themselves. In some cases, the edge controller 204 is configured to discover the first devices 210 and the second devices 212 regardless of an underlaying protocol supported by the first devices 210 and the second devices 212. In other words, the edge controller 204 can discover the first devices 210 and the second devices 212 supported by different protocols (e.g. BACnet, Modbus, LonWorks, SNMP, MQTT, Foxs, OPC UA etc.).

In an example embodiment, the edge controller 204 interrogates any devices it finds operably coupled to the network 206 to obtain additional information from those devices that further helps the edge controller 204 and/or the cloud 106 identify the connected devices, such as type of building system components, functionality of the identified building system components, connectivity of the local controllers and/or building system components, type of data that is available from the local controllers and/or building system components, types of alarms that are available from the local controllers and/or building system components, and/or any other suitable information. For purpose of brevity, the additional information requested from the devices is referred interchangeably as, ‘metadata’, ‘semantic data’, or ‘the model data’, hereinafter throughout the description.

More generally, and in some example embodiments, the edge controller 204 may be communicatively coupled to one or more assets i.e., the first assets 210 and/or the second assets 212, via one or more networks. For purpose of brevity, the term ‘assets’ is also referred interchangeably to as ‘end points’, ‘devices’, ‘sensors’, or ‘electronic devices’ throughout the description. According to various example embodiments described herein, the assets can be, for example, but not limited to, sensors, electronic components, pressure valves, HVACs, alarm units, building controllers, industrial subsystems, industrial controllers, lighting systems, air detective systems, air quality sensors, boilers, chillers, air handling units (AHUs), variable refrigerant flow (VRF) systems, pumps, etc. These may correspond to, for example, one or more of the first devices 210 and the second devices 212.

According to some example embodiments, the edge controller 204 is configured to receive the data from the one or more assets corresponding to various independent and diverse sub-systems in the facility 200 (e.g., but not limited to, a building, an industrial site, a vehicle, a warehouse, etc.). The one or more assets correspond to various independent and diverse sub-systems in the facility 200. In some examples, the data can represent time-series data and may include a plurality of data values associated with the assets which can be collected over a period of time. For instance, in an example, the telemetry data may represent a plurality of sensor readings collected by a sensor over a period of time. Additionally, in some example embodiments, the edge controller 204 may also receive model data from the one or more assets. In this regard, the model data can represent meta-data associated with the assets. The model data can be indicative of ancillary or contextual information associated with the assets. For instance, in an example, the model data can be representative of geographical information associated with an asset (e.g. location of the asset) within the facility 200. In another example, the model data can represent a sensor setting based on which a sensor is commissioned within the facility 200. In yet another example, the model data can be representative of a data type or a data format associated with the data transacted through an asset. In yet another example, the model data can be indicative of any information which can define a relationship of an asset with one or more other assets in the facility 200. In accordance with various example embodiments described herein, the term ‘model data’ can be referred interchangeably as ‘semantic model’ or ‘metadata’ for purpose of brevity.

In accordance with some example embodiments, the edge controller 204 is configured to discover and identify the one or more assets which are communicatively coupled to the edge controller 204. Further, upon identification of the assets, the example edge controller 204 is configured to pull the data that is, the telemetry data and/or the model data from the various identified assets. The edge controller 204 is configured to pull the data by sending one or more data interrogation requests to the one or more assets. These data interrogation requests can be based on a protocol supported by the one or more assets.

In accordance with an example embodiment, the edge controller 204 is configured to receive the telemetry data and/or the model data in various data formats or different data structures. For example, the model data at the edge controller 204 can be XML and/or JSON files. In an example, a format of the telemetry data and/or the model data, received at the edge controller 204 may be in accordance with a communication protocol of the network supporting transaction of data amongst two or more network nodes (i.e. the edge controller 204 and the asset). As can be appreciated, in some example embodiments, the various assets in the facility 200 can be supported by one or more of various network protocols (e.g., IOT protocols like BACnet, Modbus, LonWorks, SNMP, MQTT, Foxs, OPC UA etc.). Accordingly, and in some cases, the edge controller 204 is configured to pull the telemetry data and/or the model data, in accordance with communication protocol supported by the one or more assets.

In some example embodiments, the edge controller 204 is configured to process the received data and transform the data into a unified data format. The unified data format is referred hereinafter as a common object model. In an example, the common object model is in accordance with an object model that may be required by one or more data analytics applications or services, supported at the cloud 106. In some example embodiments, the edge controller 204 can perform data normalization to normalize the received data into a pre-defined data format. In an example, the pre-defined format can represent a common object model in which the edge controller 204 can further push the telemetry data and/or the model data to the cloud 106. In some example embodiments, the edge controller 204 is configured to establish a secure communication channel with the cloud 106. In this regard, the data can be transacted between the edge controller 204 and the cloud 106, via the secure communication channel. In some example embodiments, the gateway 202 can serve as the secure communication channel. In some example embodiments, the edge controller 204 can send the data to the cloud 106 automatically at pre-defined time intervals. In some example embodiments, at least a part of the data can correspond to historic data.

In some example embodiments, the cloud 106 can generate one or more asset models for the one or more assets in the facility 200 based at least on the telemetry data and/or the model data pushed to the cloud 106. In this regard, the one or more asset models may be associated with the one or more first devices 210a, 210b, . . . 210n or the one or more second devices 212a, 212b, . . . 212n in the facility 200. Also, in some example embodiments, the one or more asset models may be associated with one or more processes and/or operations in the facility 200 as well. In some example embodiments, the cloud 106 generates the one or more asset models based on the contextualization of the data. In this regard, the cloud 106 analyzes context such as, but not limited to a location of an asset in the facility 200, a type of parameter measured by the asset, other related assets or equipment in the facility 200, role of parameter associated with the asset, and/or the like. Further, in some example embodiments, the cloud 106 is configured to control one or more operations associated with the one or more assets in the facility 200 based at least on the one or more asset models. In this regard, the cloud 106 can undertake and/or suggest one or more suitable corrective actions as well.

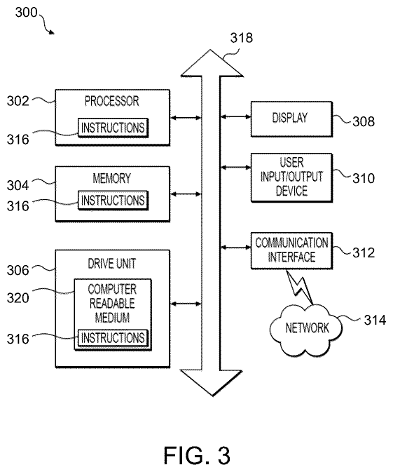

FIG. 3 illustrates a schematic diagram showing an implementation of a controller that may execute techniques in accordance with one or more example embodiments described herein. In one or more example embodiments, controller 300 described herein may include a set of instructions that can be executed to cause the controller 300 to perform any one or more of the methods or computer based functions disclosed herein. The controller 300 may operate as a standalone device or may be connected, e.g., using a network, to other computer systems or peripheral devices.

In a networked deployment, the controller 300 may operate in the capacity of a server or as a client in a server-client user network environment, or as a peer computer system in a peer-to-peer (or distributed) network environment. The controller 300 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular implementation, the controller 300 can be implemented using electronic devices that provide voice, video, or data communication. Further, while the controller 300 is illustrated as a single system, the term “system” shall also be taken to include any collection of systems or sub-systems that individually or jointly execute a set, or multiple sets, of instructions to perform one or more computer functions.

As illustrated in FIG. 3, the controller 300 may include a processor 302, e.g., a central processing unit (CPU), a graphics processing unit (GPU), or both. The processor 302 may be a component in a variety of systems. For example, the processor 302 may be part of a standard computer. The processor 302 may be one or more general processors, digital signal processors, application specific integrated circuits, field programmable gate arrays, servers, networks, digital circuits, analog circuits, combinations thereof, or other now known or later developed devices for analyzing and processing data. The processor 302 may implement a software program, such as code generated manually (i.e., programmed).

The controller 300 may include a memory 304 that can communicate via a bus 318. The memory 304 may be a main memory, a static memory, or a dynamic memory. The memory 304 may include, but is not limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one implementation, the memory 304 includes a cache or random-access memory for the processor 302. In alternative implementations, the memory 304 is separate from the processor 302, such as a cache memory of a processor, the system memory, or other memory. The memory 304 may be an external storage device or database for storing data. Examples include a hard drive, compact disc (“CD”), digital video disc (“DVD”), memory card, memory stick, floppy disc, universal serial bus (“USB”) memory device, or any other device operative to store data. The memory 304 is operable to store instructions executable by the processor 302. The functions, acts or tasks illustrated in the figures or described herein may be performed by the processor 302 executing the instructions stored in the memory 304. The functions, acts or tasks are independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel processing and the like.

As shown, the controller 300 may further include a display 308, such as a liquid crystal display (LCD), an organic light emitting diode (OLED), a flat panel display, a solid-state display, a cathode ray tube (CRT), a projector, a printer or other now known or later developed display device for outputting determined information. The display 308 may act as an interface for the user to see the functioning of the processor 302, or specifically as an interface with the software stored in the memory 304 or in the drive unit 306. Additionally or alternatively, the controller 300 may include an input/output device 310 configured to allow a user to interact with any of the components of controller 300. The input/output device 310 may be a number pad, a keyboard, or a cursor control device, such as a mouse, or a joystick, touch screen display, remote control, or any other device operative to interact with the controller 300. The controller 300 may also or alternatively include drive unit 306 implemented as a disk or optical drive. The drive unit 306 may include a computer-readable medium 320 in which one or more sets of instructions 316, e.g. software, can be embedded. Further, the instructions 316 may embody one or more of the methods or logic as described herein. The instructions 316 may reside completely or partially within the memory 304 and/or within the processor 302 during execution by the controller 300. The memory 304 and the processor 302 also may include computer-readable media as discussed above.

In some systems, a computer-readable medium 320 includes instructions 316 or receives and executes instructions 316 responsive to a propagated signal so that a device connected to a network 314 can communicate voice, video, audio, images, or any other data over the network 314. Further, the instructions 316 may be transmitted or received over the network 314 via a communication port or interface 312, and/or using a bus 318. The communication port or interface 312 may be a part of the processor 302 or may be a separate component. The communication port or interface 312 may be created in software or may be a physical connection in hardware. The communication port or interface 312 may be configured to connect with a network 314, external media, the display 308, or any other components in controller 300, or combinations thereof. The connection with the network 314 may be a physical connection, such as a wired Ethernet connection or may be established wirelessly as discussed below. Likewise, the additional connections with other components of the controller 300 may be physical connections or may be established wirelessly. The network 314 may alternatively be directly connected to a bus 318.

While the computer-readable medium 320 is shown to be a single medium, the term “computer-readable medium” may include a single medium or multiple media, such as a centralized or distributed database, and/or associated caches and servers that store one or more sets of instructions. The term “computer-readable medium” may also include any medium that is capable of storing, encoding, or carrying a set of instructions for execution by a processor or that cause a computer system to perform any one or more of the methods or operations disclosed herein. The computer-readable medium 320 may be non-transitory, and may be tangible. The computer-readable medium 320 can include a solid-state memory such as a memory card or other package that houses one or more non-volatile read-only memories. The computer-readable medium 320 can be a random-access memory or other volatile re-writable memory. Additionally or alternatively, the computer-readable medium 320 can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative implementation, dedicated hardware implementations, such as application specific integrated circuits, programmable logic arrays and other hardware devices, can be constructed to implement one or more of the methods described herein. Applications that may include the apparatus and systems of various implementations can broadly include a variety of electronic and computer systems. One or more implementations described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

The controller 300 may be connected to a network 314. The network 314 may define one or more networks including wired or wireless networks. The wireless network may be a cellular telephone network, an 802.11, 802.16, 802.20, or WiMAX network. Further, such networks may include a public network, such as the Internet, a private network, such as an intranet, or combinations thereof, and may utilize a variety of networking protocols now available or later developed including, but not limited to TCP/IP based networking protocols. The network 314 may include wide area networks (WAN), such as the Internet, local area networks (LAN), campus area networks, metropolitan area networks, a direct connection such as through a Universal Serial Bus (USB) port, or any other networks that may allow for data communication. The network 314 may be configured to couple one computing device to another computing device to enable communication of data between the devices. The network 314 may generally be enabled to employ any form of machine-readable media for communicating information from one device to another. The network 314 may include communication methods by which information may travel between computing devices. The network 314 may be divided into sub-networks. The sub-networks may allow access to all of the other components connected thereto or the sub-networks may restrict access between the components. The network 314 may be regarded as a public or private network connection and may include, for example, a virtual private network or an encryption or other security mechanism employed over the public Internet, or the like.

In accordance with various implementations of the present disclosure, the methods described herein may be implemented by software programs executable by a computer system. Further, in an exemplary, non-limited implementation, implementations can include distributed processing, component/object distributed processing, and parallel processing. Alternatively, virtual computer system processing can be constructed to implement one or more of the methods or functionality as described herein.

Although the present specification describes components and functions that may be implemented in particular implementations with reference to particular standards and protocols, the disclosure is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof. It will be understood that the steps of methods discussed are performed in one embodiment by an appropriate processor (or processors) of a processing (i.e., computer) system executing instructions (computer-readable code) stored in storage. It will also be understood that the disclosure is not limited to any particular implementation or programming technique and that the disclosure may be implemented using any appropriate techniques for implementing the functionality described herein. The disclosure is not limited to any particular programming language or operating system.

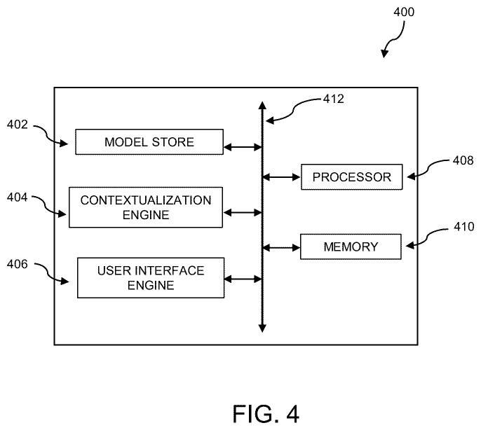

FIG. 4 illustrates a schematic diagram showing an implementation of an exemplary asset modelling system. In one or more example embodiments, the asset modelling system 400 described herein facilitates management of one or more assets and/or operations in a facility. Per this aspect, the asset modelling system 400 described herein generates one or more asset models for the one or more assets in the facility. Also, the asset modelling system 400 utilizes the one or more generated asset models to manage the one or more assets and/or operations in the facility. In this regard, for instance, the asset modelling system 400 controls the one or more assets and/or operations in the facility using the one or more generated asset models. For example, based on the one or more asset models, the asset modelling system 400 can change a value of an operating point of a boiler. In another example, based on the one or more asset models, the asset modelling system 400 can modify a schedule of operation of a chiller. In some example embodiments, to model the one or more assets, the asset modelling system 400 initially receives data associated with the one or more assets. Further, in some example embodiments, the asset modelling system 400 also retrieves some of existing data models associated with the one or more assets. Using at least the retrieved data models, in some example embodiments, the asset modelling system 400 contextualizes the data. In this regard, the asset modelling system 400 analyzes context associated with the data. Then, the asset modelling system 400 generates the suitable asset models using the contextualized data. Also, in some example embodiments, the asset modelling system 400 makes sure to update the existing data models with the one or more generated asset models. Additionally, in some example embodiments, the asset modelling system 400 also generates one or more relevant dashboards based at least on the updated data models to render relevant content associated with the one or more assets and/or operations in the facility. In this regard, the asset modelling system 400 generates relevant user interfaces renderable on display of electronic devices. Accordingly, in one or more example embodiments, the system 400 facilitates a practical application of data analytics technology and/or digital transformation technology to suitably model the assets and render appropriate dashboards for efficient operations in the facility.

In some example embodiments, the asset modelling system 400 is a server system (e.g., a server device) that facilitates a data analytics platform between one or more computing devices, one or more data sources, and/or one or more assets in the facility. In some example embodiments, the asset modelling system 400 is a device with one or more processors and a memory. Whereas in some example embodiments, the asset modelling system 400 is implementable via the cloud 106. In some example embodiments, the asset modelling system 400 may be a part of building management system (BMS) or building supervisor platform of the facility. Whereas in some example embodiments, the asset modelling system 400 may be communicatively coupled to BMS or building supervisor platform of the facility. The asset modelling system 400 is implementable in one or more facilities related to one or more technologies, for example, but not limited to, enterprise technologies, connected building technologies, industrial technologies, Internet of Things (IoT) technologies, data analytics technologies, digital transformation technologies, cloud computing technologies, cloud database technologies, server technologies, network technologies, private enterprise network technologies, wireless communication technologies, machine learning technologies, artificial intelligence technologies, digital processing technologies, electronic device technologies, computer technologies, supply chain analytics technologies, aircraft technologies, industrial technologies, cybersecurity technologies, navigation technologies, asset visualization technologies, oil and gas technologies, petrochemical technologies, refinery technologies, process plant technologies, procurement technologies, and/or one or more other technologies.

In some example embodiments, the asset modelling system 400 comprises one or more components (alternatively, referred to as one or more modules) such as, a model store 402, a contextualization engine 404, and/or a user interface engine 406. Additionally, the asset modelling system 400 can comprise a processor 408 and/or a memory 410. In one or more example embodiments, one or more components of the asset modelling system 400 may be communicatively coupled to the processor 408 and/or the memory 410 via a bus 412. In some example embodiments, the one or more components of the asset modelling system 400 may be communicatively coupled to the processor 408 and/or the memory 410 via a network such as, nut not limited to a Wi-Fi network, a Near Field Communications (NFC) network, a Worldwide Interoperability for Microwave Access (WiMAX) network, a personal area network (PAN), a short-range wireless network (e.g., a Bluetooth® network), an infrared wireless (e.g., IrDA) network, an ultra-wideband (UWB) network, an induction wireless transmission network, a BACnet network, a NIAGARA network, a NIAGARA CLOUD network, and/or another type of network. In certain example embodiments, one or more aspects of the asset modelling system 400 (and/or other systems, apparatuses and/or processes disclosed herein) constitute executable instructions embodied within a computer-readable storage medium (e.g., the memory 410). For instance, in an example embodiment, the memory 410 stores computer executable component and/or executable instructions (e.g., program instructions). Furthermore, the processor 408 facilitates execution of the computer executable components and/or the executable instructions (e.g., the program instructions). In an example embodiment, the processor 408 is configured to execute instructions stored in memory 410 or otherwise accessible to the processor 408.

The processor 408 is a hardware entity (e.g., physically embodied in circuitry) capable of performing operations according to one or more embodiments of the disclosure. Alternatively, in an example embodiment where the processor 408 is embodied as an executor of software instructions, the software instructions configure the processor 408 to perform one or more algorithms and/or operations described herein in response to the software instructions being executed. In an example embodiment, the processor 408 is a single core processor, a multi-core processor, multiple processors internal to the asset modelling system 400, a remote processor (e.g., a processor implemented on a server), and/or a virtual machine. In certain example embodiments, the processor 408 is in communication with the memory 410, the model store 402, the contextualization engine 404, and/or the user interface engine 406 via the bus 412 to, for example, facilitate transmission of data between the processor 408, the memory 410, the model store 402, the contextualization engine 404, and/or the user interface engine 406. In some example embodiments, the processor 408 may be embodied in a number of different ways and, in certain example embodiments, includes one or more processing devices configured to perform independently. Additionally or alternatively, in one or more example embodiments, the processor 408 includes one or more processors configured in tandem via bus 412 to enable independent execution of instructions, pipelining of data, and/or multi-thread execution of instructions.

The memory 410 is non-transitory and includes, for example, one or more volatile memories and/or one or more non-volatile memories. In other words, in one or more example embodiments, the memory 410 is an electronic storage device (e.g., a computer-readable storage medium). The memory 410 is configured to store information, data, content, one or more applications, one or more instructions, or the like, to enable the asset modelling system 400 to carry out various functions in accordance with one or more embodiments disclosed herein. In accordance with some example embodiments described herein, the memory 410 may correspond to an internal or external memory of the asset modelling system 400. In some examples, the memory 410 may correspond to a database communicatively coupled to the asset modelling system 400. As used herein in this disclosure, the term “component,” “system,” and the like, is a computer-related entity. For instance, “a component,” “a system,” and the like disclosed herein is either hardware, software, or a combination of hardware and software. As an example, a component is, but is not limited to, a process executed on a processor, a processor circuitry, an executable component, a thread of instructions, a program, and/or a computer entity.

In some example embodiments described herein, the model store 402 of the asset modelling system 400 comprises one or more data models. In this regard, the one or more data models provide relevant information pertaining to the one or more assets, the one or more operations/processes in the facility, and/or the facility itself. In some example embodiments, the one or more data models comprise one or more knowledge graphs. In this regard, the one or more knowledge graphs may define a collection of nodes and links that describe real-world connections that enable smart systems. As used herein, a knowledge graph: (i) describes real-world entities (e.g., assets, processes, facilities, and/or the like) and their interrelations organized in a graphical interface; (ii) defines possible classes and relations of entities in a schema; (iii) enables interrelating arbitrary entities with each other; and (iv) covers various topical domains. In other words, the knowledge graphs define large networks of entities (e.g., assets, processes, facilities, and/or the like), semantic types of the entities, properties of the entities, and relationships between the entities. In this regard, the knowledge graph may comprise one or more assets as nodes and interrelations between the one or more assets as links. Further, the knowledge graph may comprise one or more facilities as nodes and interrelations between the one or more facilities as links. Also, the knowledge graph may comprise various portions of a facility as nodes and interrelations between the various portions of the facility as links. Yet, the knowledge graph may comprise hierarchy associated with assets as nodes and interrelations between the hierarchy associated with assets as links. Thus, the knowledge graphs describe a network of “things” that are relevant to a specific domain or to an enterprise or organization. Knowledge graphs can also contain instances of objects, such as, for example, documents and datasets.

In some example embodiments, the knowledge graphs include resource description framework (RDF) graphs. As used herein, a “RDF graph” is a graph data model that formally describes the semantics, or meaning, of information. The RDF graph also represents metadata (e.g., data that describes data). In this regard, the metadata can be, but not limited to a location of an asset in the facility, a type of parameter measured by the asset, other related assets or equipment in the facility, role of parameter associated with the asset, a location of the facility, nature of the facility, and/or the like. In this regard, the type of parameter measured by the asset can be, but not limited to temperature, pressure, fan speed, flow rate, and/or the like. While the role of parameter associated with the asset can be, but not limited to a set point, a desired point that is to be maintained by the asset, operational status of the asset, and/or the like. According to various embodiments, knowledge graphs also include a semantic object model. The semantic object model is a subset of a knowledge graph that defines semantics for the knowledge graph. For example, the semantic object model defines the schema for the knowledge graph. In some example embodiments, the knowledge graphs can also comprise historical data associated with large networks of entities (e.g., assets, processes, facilities, and/or the like). In this regard, the historical data may correspond to historical telemetry data associated with the assets, service cases associated with the assets and/or the overall facility, maintenance logs associated with the assets and/or the overall facility, standard operating procedures with respect to the assets, processes, and/or facilities, naming conventions, and/or the like. Also, in some example embodiments, the one or more data models can be visualized as well. In this regard, the knowledge graphs facilitate visualization of the one or more data models as graphs with nodes and links. Further, in some example embodiments, the model store 402 of the asset modelling system 400 is extensible as well. Said alternatively, the model store 402 allows to add one or more new models to the existing one or more data models. In this regard, the one or more new models can correspond to the one or more asset models associated with the assets and/or one or more new data models as well. Additionally, in some example embodiments, the one or more data models of the model store 402 are extensible as well. Said alternatively, the model store 402 allows the one or more data models to include new properties/columns/fields, new classes/tables, new relations, and/or the like. In some example embodiments described herein, the model store 402 can store the one or more data models for a pre-defined period of time. Also, in some example embodiments, at least some of the one or more data models may be stored in the memory 410 of the asset modelling system 400 as well.

Then, in some example embodiments, the contextualization engine 404 of the asset modelling system 400 receives data associated with the one or more assets in the facility. Per this aspect, the data associated with the one or more assets comprises model data and/or telemetry data. In this regard, the model data can represent meta-data associated with the assets. The model data can be indicative of ancillary or contextual information associated with the assets. For instance, in an example, the model data can be representative of geographical information associated with an asset (e.g. location of the asset) within the facility. In another example, the model data can represent a sensor setting based on which a sensor is commissioned within the facility. In yet another example, the model data can be representative of a data type or a data format associated with the data transacted through an asset. In yet another example, the model data can be indicative of any information which can define a relationship of an asset with one or more other assets in the facility. Also, in another example, the model data can be indicative of hierarchical relations of the one or more assets in the facility as well. In accordance with some examples, the model data can be received as XML and/or JSON files at the contextualization engine 404. Further, in one or more example embodiments, the telemetry data represents sensor data from one or more sensors associated with the one or more assets. In this regard, the telemetry data may be received in real time and/or near real time. In some examples, the contextualization engine 404 may receive the data directly from the one or more assets in the facility. In this regard, the contextualization engine 404 may further pre-process the data received from the one or more assets. For example, the contextualization engine 404 may filter the data and translate the data into a common language and/or format (e.g. normalized data) for subsequent processing and/or analysis. Whereas in some other examples, the contextualization engine 404 may receive the data from a gateway (for instance, gateway 202 described in accordance with FIG. 2 of the current disclosure) and/or an edge controller (for instance, edge controller 104 described in accordance with FIG. 1 or edge controller 204 described in accordance with FIG. 2) installed in the facility. In this regard, the contextualization engine 404 may directly utilize the data received from the one or more assets for subsequent processing and/or analysis.

In one or more example embodiments described herein, the contextualization engine 404 generates one or more asset models for respective assets based at least on the data received at the contextualization engine 404. Per this aspect, in some example embodiments, the contextualization engine 404 initially contextualizes the received data. In this regard, the contextualization engine 404 analyzes context such as, but not limited to a location of an asset in the facility, a type of parameter measured by the asset, other related assets or equipment in the facility, role of parameter associated with the asset, and/or the like of the received data. For example, when an air handling unit (AHU) of an industrial plant is to be modelled, the contextualization engine 404 based at least on the received data analyzes context such as location of the AHU, temperature maintained by the AHU in an area served by the AHU, relation with other equipment where the AHU is serving in the facility, determining whether the temperature corresponds to a set point or zone temperature, and/or the like. In some example embodiments, the contextualization engine 404 described herein has natural language processing capabilities to analyze the context associated with the data. In some example embodiments, the contextualization engine 404 also retrieves the one or more data models associated with the one or more assets in the facility to contextualize the received data. In this regard, the contextualization engine 404 retrieves the one or more data models from the model store 402 and/or memory 410. Then, in accordance with one or more example embodiments, the contextualization engine 404 also utilizes at least some of the details from the one or more data models to contextualize the data received at the contextualization engine 404. For instance, the contextualization engine 404 can utilize the one or more data models to identify additional context such as geographical location of the facility in which the asset is located, nature of facility in which the asset is located, one or more operational procedures of the facility, naming conventions used in the facility, and/or the like. In this regard, the accuracy associated with modelling of the one or more assets in the facility is improved. Considering the aforementioned example, i.e., when the AHU of the industrial plant is to be modelled in the facility, the contextualization engine 404 utilizes the one or more data models to identify additional context such as geographical location of the industrial plant in which the AHU is located, nature of the industrial plant in which the AHU is located, one or more operational procedures of the industrial plant, naming conventions used for naming AHU in the industrial plant, and/or the like.

Further, in one or more example embodiments, the contextualization engine 404 utilizes at least the contextualized data to generate the one or more asset models for the corresponding to the one or more assets. In this regard, the contextualization engine 404 creates a model with one or more of: an identifier of an asset, one or more devices associated with the asset, one or more operating points of the asset, a role of each of the one or more operating points of the asset, and a schedule of operation for the asset. For example, to generate an asset model for the AHU of the industrial plant, the contextualization engine 404 creates a model with one or more of: an identifier of the AHU, one or more devices associated with the AHU, one or more operating points of the AHU, a role of each of the one or more operating points of the AHU, and a schedule of operation for the AHU. In one or more example embodiments, the contextualization engine 404 with regards to generation of an asset model say, for an asset may initially extract one or more details associated with the asset from the contextualized data. Also, in some example embodiments, the contextualization engine 404 considers one or more operational procedures of the facility and/or naming conventions used in the facility with regards to generation of the asset model. Per this aspect, the accuracy associated with modelling of the one or more assets in the facility is improved. In this regard, the contextualization engine 404 determines an identifier such as name of the asset, location of the asset in the facility, name of the facility in which the asset is located, nature of facility, and/or the like. For example, the aforementioned AHU may be located in “Floor 1” of the industrial plant named “K1”. To generate an asset model for the AHU of the industrial plant, the contextualization engine 404 first determines that the asset to be modelled is an air handling unit (AHU), the AHU is located in Floor 1 of facility K1, and the facility K1 is an industrial plant. Then, in one or more example embodiments, the contextualization engine 404 identifies one or more operating points of the asset, a role of each of the one or more operating points of the asset, and/or the like. For example, the aforementioned AHU may be operating at a defined value, and this may correspond to a set point at which the AHU is operating. Further, in one or more example embodiments, the contextualization engine 404 assigns one or more operating points of the asset and point roles for each of the operating points for the asset as a part of creation of the asset model. In some examples, the contextualization engine 404 may perform the assignment for one asset. Whereas, in some other examples, the contextualization engine 404 may perform the assignment for multiple assets. For example, if three additional AHUs similar to that of the aforementioned AHU are to be modelled, the contextualization engine 404 may perform bulk assignment for the additional AHUs as well.

Furthermore, in one or more example embodiments described herein, the contextualization engine 404 also creates one or more schedules for operating the asset as a part of creation of the asset model. In this regard, the contextualization engine 404 may also consider interrelationship between the assets to create the one or more schedules for the assets. In some examples, the one or more schedules represent a type of action to be taken by the asset at a particular point of time. For example, at a particular time, as per a first schedule, the AHU may be configured to operate at a particular set point. In another example, at a particular time, as per a second schedule, the AHU may be configured to maintain a zone temperature of Floor 1. Yet in another example, at a particular time, as per a third schedule, the AHU may be configured to operate with a particular fan speed. Also, in another example, at a particular time, as per a fourth schedule, the AHU may be configured to be in either ON state or OFF state. Per this aspect, the asset operates based on the one or more created schedules. In this regard, the contextualization engine 404 facilitates efficient operation of the one or more assets in the facility based on the creation of appropriate schedules for the respective assets. Accordingly, the asset model generated for the asset comprises one or more details such as, but not limited to identifier of the asset, one or more devices associated with the asset, assigned operating points and point roles of the asset, and a schedule of operation for the asset. In some examples, the contextualization engine 404 may automatically generate the one or more asset models. Whereas in some other examples, the contextualization engine 404 may generate the one or more asset models based on a request received from a user such as an operator in the facility. Then, in some example embodiments, the one or more data models in the model store 402 may be updated with the asset model generated for the asset as well. Additionally, in some example embodiments described herein, the contextualization engine 404 controls one or more operations associated with the one or more assets based at least on the updated data models in the model store 402. In this regard, the contextualization engine 404 may change a value of an operating point of an asset of the one or more assets, change a role of the operating point of an asset of the one or more assets, and/or modify a schedule of operation of an asset of the one or more assets in the facility as a part of controlling operations associated with the one or more assets. Additionally, in some example embodiments, the contextualization engine 404 learns modelling of the assets over period of time to improve accuracy of generation of the one or more models. Also, in some example embodiments, the contextualization engine 404 determines one or more key performance indicators (KPIs) and/or trends associated with the one or more assets based on the one or more asset models.

In one or more example embodiments, the user interface engine 406 utilizes the one or more updated data models to generate one or more dashboards. Also, in some example embodiments, the contextualization engine 404 can transmit the one or more asset models to the user interface engine 406 to generate relevant dashboards. The user interface engine 406 utilizes suitable data from the one or more data models and/or asset models to generate relevant dashboards. In this regard, the user interface engine 406 generates one or more dashboards to render relevant content associated with the one or more assets in the facility. In some examples, the user interface engine 406 generates a first dashboard with at least one of: an identifier of an operating point of an asset, one or more devices associated with the asset, a category of the asset, and a role of the operating point associated with the asset. Then, in some examples, the user interface engine 406 generates a second dashboard with at least one of: the identifier of the operating point of the asset, a device associated with the operating point of the asset, the category of the asset, and a schedule of operation for the asset. Further, in some examples, the user interface engine 406 generates a third dashboard with at least one of: a value associated with the operating point of the asset, an operational status of the asset, one or more key performance indicators associated with the asset, and an operational trend associated with the asset. In one or more example embodiments, the user interface engine 406 transmits the relevant dashboards to one or more devices associated with users in the facility for viewing. In this regard, the relevant dashboards can be rendered on display of respective one or more devices.

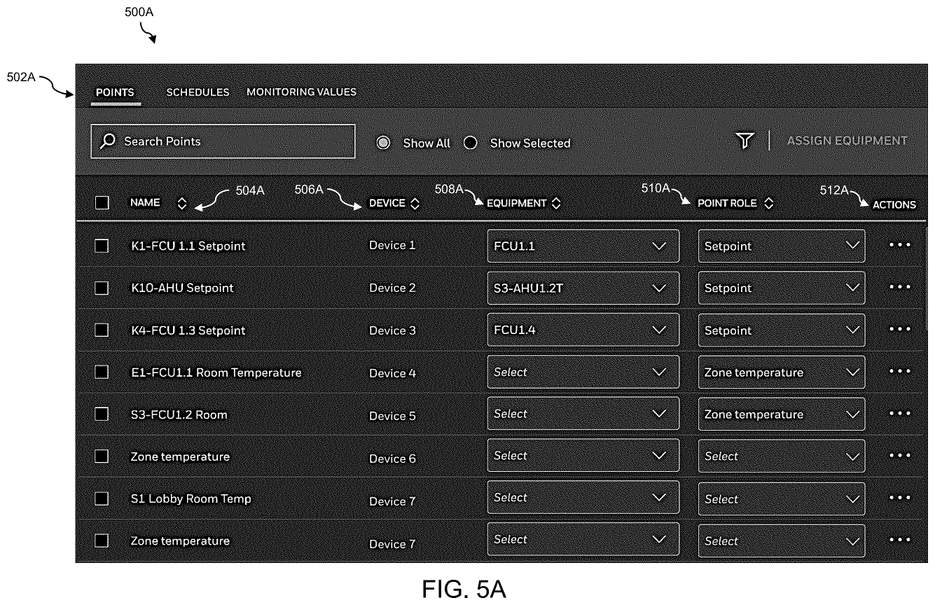

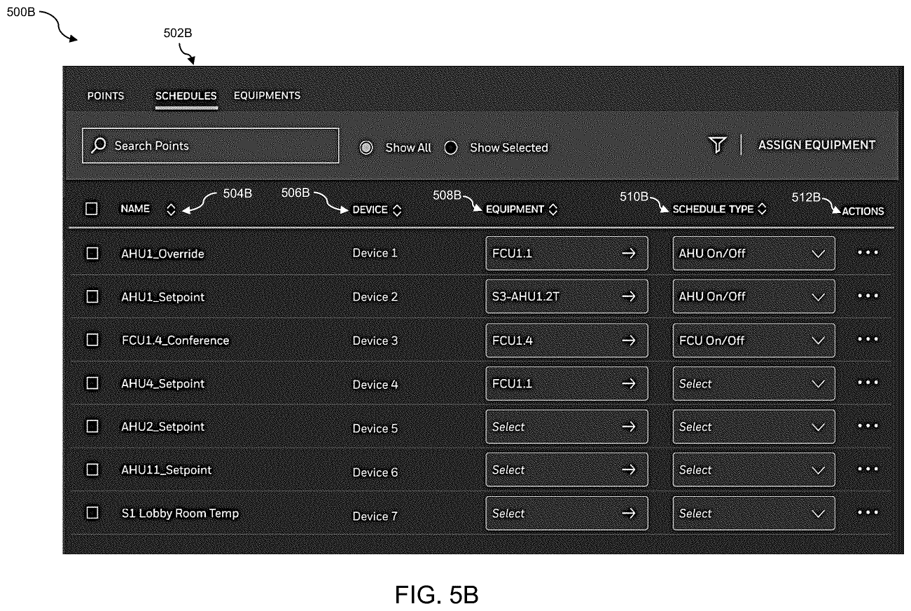

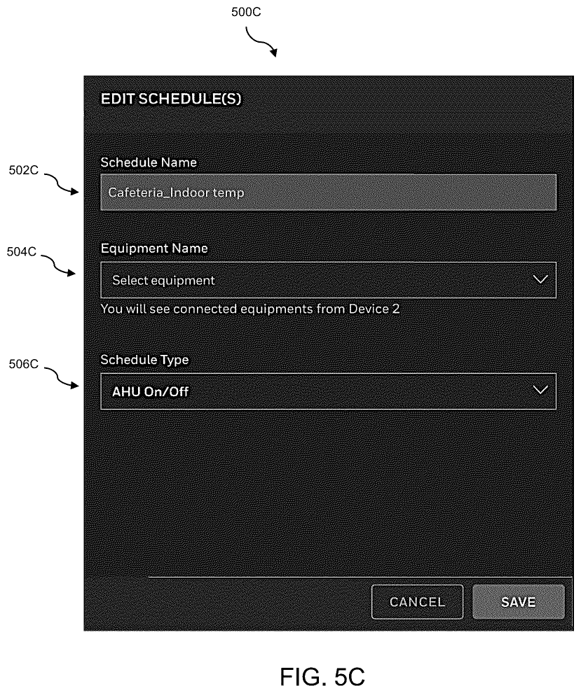

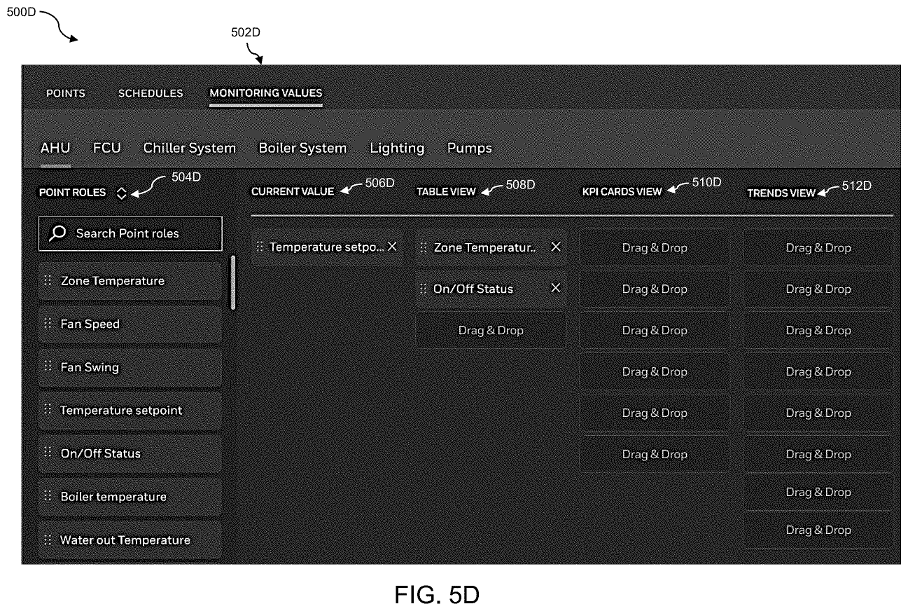

Also, in some embodiments described herein, the user interface engine 406 renders the one or more dashboards based at least on user preferences such as preferences set by operators, field engineers, and/or the like in the facility. For example, the user may set preferences such as specific operating points, specific set of assets, assets of specific portion of the facility, specific point roles of the assets, and/or the like. In this regard, the user interface engine 406 facilitates customization of content to be viewed as dashboards so that only relevant content is rendered as dashboards. Also, the user interface engine 406 allows the user to provide one or more inputs via display of suitable device. The one or more inputs can be associated with modification to the dashboards such as removal of content associated with specific assets, specific operating points, specific point roles, and/or the like from a dashboard, modification of assignment of a point to an asset, modification of a point role of an asset, and/or the like. In some example embodiments, the one or more data models and/or the one or more asset models can be updated based on the one or more inputs as well. Also, in some example embodiments, the user interface engine 406 also tracks a pattern of usage associated with each of the one or more dashboards. In this regard, the user interface engine 406 learns over a period of time most relevant content preferred by one or more users in the facility. For example, a user may frequently prefer to view details of AHUs, pumps, and boilers of a particular location of the facility. Accordingly, the user interface engine 406 renders the relevant content for a particular user based on their usage patterns. That is, for example, the user interface engine 406 automatically renders details for AHUs, pumps, and boilers of a particular location of the facility when the particular user logs in. Additionally, in some example embodiments, the user interface engine 406 generates one or more templates or profiles based on the usage patterns as well. In this regard, the one or more templates or profiles can be stored in the model store 402 and/or memory 410. As it may be understood, the dashboards described herein are exemplary only and the user interface engine 406 may render any other relevant dashboard or combination of aforementioned dashboards as well. Also, some example dashboards are described in more details in accordance with FIGS. 5A-5D of the current disclosure.

FIG. 5A illustrates a schematic diagram showing an exemplary user interface associated with an exemplary asset modelling system. In one or more example embodiments, a dashboard 500A is an electronic interface that is presented via a display of a device such as a computing device (not shown) associated with a user in a facility. In some example embodiments described herein, the dashboard 500A corresponds to a first dashboard described in accordance with FIG. 4 of the current disclosure. Also, the dashboard 500A is generated by the user interface engine 406 described in accordance with FIG. 4 of the current disclosure. In one or more examples, the dashboard 500A comprises a tab named point 502A. In this regard, the tab point 502A of the dashboard 500A provides all relevant information associated with assigned operating points and point roles of the assets using the one or more asset models. That is, the tab point 502A of the dashboard 500A comprises name of operating point 504A, name of device 506A, name of asset 508A, point role 510A, and/or actions 512A. The name of operating point 504A indicates details of an operating point of an asset. For example, “K10-AHU Setpoint” under the name of operating point 504A in dashboard 500A indicates that the operating point is a set point, and the asset is air handling unit (AHU) located at a zone named as K10 of a facility. Said alternatively, this indicates that the operating point is a set point of AHU of zone K10 in the facility. Then, the name of device 506A indicates a component of an asset or equipment associated with the operating point as in the name of operating point 504A. Further, the name of asset 508A provides an identifier or a category of an asset or equipment for the corresponding operating point as in the name of operating point 504A. Furthermore, the point role 510A indicates a role of an operating point as in the name of operating point 504A. In this regard, the role can be one of: a set point, a zone temperature, a fan speed, and ON/OFF status. Additionally, the actions 512A allow a user to provide one or more inputs in order to choose one or more actions. In this regard, the actions 512A provide one or more choices such as to assign an asset/equipment and/or assign point role for an operating point. Accordingly, the user can select one or more actions and provide appropriate inputs. For example, if the user determines that the operating point “K10-AHU Setpoint” is no longer a set point but corresponds to a zone temperature, the user can choose assign point role action and provide an input to change the point role from set point to zone temperature. In another example, if the user determines that the operating point “K10-AHU Setpoint” is also associated with another equipment/asset, the user can choose to assign an asset/equipment action and provide an input to assign the operating point “K10-AHU Setpoint” to another equipment/asset as well. Also, the dashboard 500A allows the user to select multiple operating points to choose a same action for the multiple operating points. Based on such inputs, the data models and/or the asset models described in accordance with FIG. 4 of the current disclosure can be updated as well.

FIG. 5B illustrates a schematic diagram showing an exemplary user interface associated with an exemplary asset modelling system. In one or more example embodiments, a dashboard 500B is an electronic interface that is presented via a display of a device such as a computing device (not shown) associated with a user in a facility. In some example embodiments described herein, the dashboard 500B corresponds to a second dashboard described in accordance with FIG. 4 of the current disclosure. Also, the dashboard 500B is generated by the user interface engine 406 described in accordance with FIG. 4 of the current disclosure. In one or more examples, the dashboard 500B comprises a tab named schedules 502B. In this regard, schedules 502B of the dashboard 500B provides all relevant information associated with schedule of operation of the assets using the one or more asset models. That is, schedules 502B of the dashboard 500B comprises name of operating point 504B, name of device 506B, name of asset 508B, schedule of operation 510B, and/or actions 512B. The name of operating point 504B indicates details of an operating point of an asset. For example, “AHU1_Setpoint” under the name of operating point 504B in dashboard 500B indicates that the operating point is a set point, and the asset is air handling unit (AHU). Then, the name of device 506B indicates a component of an asset or equipment associated with the operating point as in the name of operating point 504B. Further, the name of asset 508B provides an identifier or a category of an asset or equipment for the corresponding operating point as in the name of operating point 504B. For example, identifier “S3-AHU1.2T” under the name of asset 508B indicates that the operating point “AHU1_Setpoint” is associated with AHU at a zone S3 of a facility. Furthermore, the schedule of operation 510B indicates a type of operation for an asset for the corresponding operating point as in the name of operating point 504B. In this regard, the schedule of operation can be one of: a set point, a zone temperature, a fan speed, and ON/OFF status. The assets operate at the corresponding operating point as in the name of operating point 504B based on the schedule of operation 510B. Additionally, the actions 512B allow a user to provide one or more inputs in order to choose one or more actions. In this regard, the actions 512B provide one or more choices such as to assign an asset/equipment and/or change a schedule for an operating point. Accordingly, the user can select one or more actions and provide appropriate inputs. For example, if the user determines that the operating point “AHU1_Setpoint” is also associated with another equipment/asset, the user can choose to assign an asset/equipment action and provide an input to assign the operating point “AHU1_Setpoint” to another equipment/asset as well. Also, the dashboard 500B allows the user to select multiple operating points to choose a same action for the multiple operating points. Based on such inputs, the data models and/or the asset models described in accordance with FIG. 4 of the current disclosure can be updated as well.

FIG. 5C illustrates a schematic diagram showing an exemplary user interface associated with an exemplary asset modelling system. In one or more example embodiments, a dashboard 500C is an electronic interface that is presented via a display of a device such as a computing device (not shown) associated with a user in a facility. In some example embodiments described herein, the dashboard 500C corresponds to an additional dashboard with regards to a second dashboard described in accordance with FIG. 4 of the current disclosure. Also, the dashboard 500C is generated by the user interface engine 406 described in accordance with FIG. 4 of the current disclosure. In one or more examples, the dashboard 500C is generated with regards to changing a schedule for an operating point of the actions 512B as described in FIG. 5B of the current disclosure. Per this aspect, the dashboard 500C comprises name of schedule 502C, asset/equipment name 504C, and/or schedule type 506C. The name of schedule 502C comprises details of parameters to be changed in a particular zone or location of a facility. For example, “Cafeteria_Indoor temp” under the name of schedule 502C in dashboard 500C indicates that the parameter to be changed in temperature and specifically indoor temperature of cafeteria of a facility. Then, the asset/equipment name 504C provides one or more assets related to the name of schedule 502C. Further, the schedule type 506C facilitates selection of a modification to a current schedule. For example, one or more AHUs may be serving the cafeteria to maintain a constant indoor temperature. But a user may now desire to turn off the one or more AHUs serving the cafeteria. In this regard, the user may select an option of AHU On/Off to turn off the one or more AHUs. Accordingly, the dashboard 500C allows modification to operation schedules of one or more assets in order to control their operations in the facility.

FIG. 5D illustrates a schematic diagram showing an exemplary user interface associated with an exemplary asset modelling system. In one or more example embodiments, a dashboard 500D is an electronic interface that is presented via a display of a device such as a computing device (not shown) associated with a user in a facility. Also, the dashboard 500D is generated by the user interface engine 406 described in accordance with FIG. 4 of the current disclosure. In one or more examples, the dashboard 500D comprises a tab named monitoring values 502D. In this regard, the tab monitoring values 502D comprises point role 504D, current value 506D, table view 508D, key performance indicator (KPI) cards view 510D, and/or trends view 512D. The dashboard 500D allows a user to customize details to be viewed on the dashboard 500D. In this regard, the user can choose (for example, drag and drop) one or more fields in the dashboard 500D as a part of customization of the dashboard 500D. The point role 504D comprises one or more role of operating points in a facility. For example, the role can be, but not limited to zone temperature, fan speed, fan swing, temperature setpoint, On/Off Status, boiler temperature, water out temperature, and/or the like. Then, the current value 506D comprises those operating point(s) of which current value(s) is to be rendered on the dashboard 500D as per user's preference. For example, the user may desire to view current value of temperature set point of all assets in the facility. In this regard, the user may just drag “temperature setpoint” from the point role 504D and drop it under the current value 506D. The table view 508D comprises those role(s) of operating point(s) which the user prefers to be viewed as a table. For example, the user may desire to view zone temperature and On/Off Status of all assets in the facility as a tabulated view. In this regard, the user may just drag “zone temperature” from the point role 504D and drop it under the table view 508D. Then, the user may drag “On/Off Status” from the point role 504D and drop it under the table view 508D. Also, after dropping, the user may prioritize the role(s) to be displayed by moving the appropriate role(s) up/down in the table view 508D as well. The key performance indicator (KPI) cards view 510D comprises those operating point(s) of which KPI is to be rendered on the dashboard 500D as per user's preference. Then, the trends view 512D comprises those operating point(s) of which one or more trends is to be rendered on the dashboard 500D as per user's preference. In this regard, the one or more trends can correspond to one or more graphical representations associated with performance of assets. Accordingly, the dashboard 500D facilitates display of only relevant content to the user in the facility. Also, the user interface engine 406 learns such usage patterns and/or user preferences over a period of time to render only appropriate details to the user in the facility.

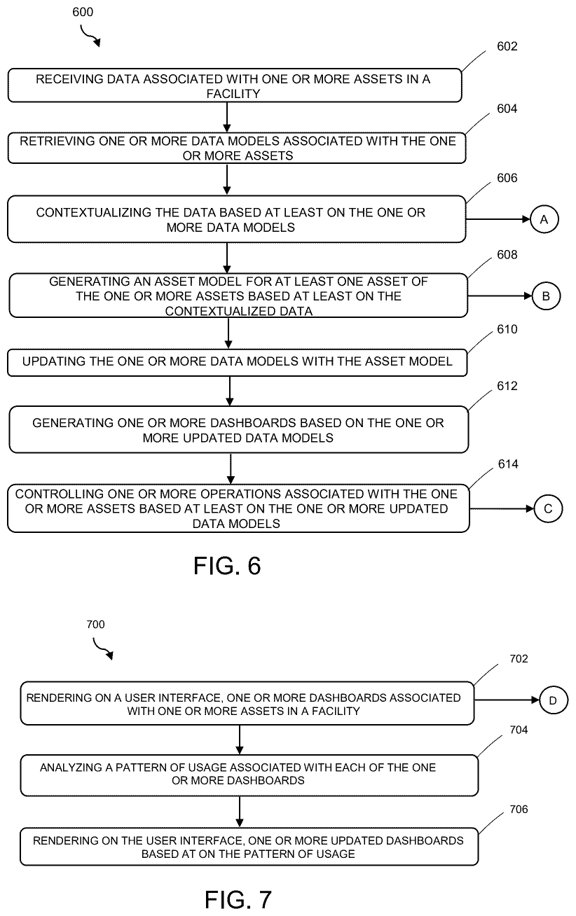

FIG. 6 illustrates a flowchart showing a method described in accordance with one or more example embodiments described herein. The exemplary flowchart 600 described herein is implementable via the asset modelling system 400 described in accordance with FIG. 4 of current disclosure. At step 602 of exemplary flowchart 600, the asset modelling system 400 comprises means such as, the contextualization engine 404 to receive data associated with one or more assets in a facility. At step 604 of exemplary flowchart 600, the asset modelling system 400 comprises means such as, the contextualization engine 404 to retrieve one or more data models associated with the one or more assets say, from model store 402. At step 606 of exemplary flowchart 600, the asset modelling system 400 comprises means such as, the contextualization engine 404 to contextualize the data based at least on the one or more data models. Then, at step 608 of exemplary flowchart 600, the asset modelling system 400 comprises means such as, the contextualization engine 404 to generate an asset model for at least one asset of the one or more assets based at least on the contextualized data. Further, at step 610 of exemplary flowchart 600, the asset modelling system 400 comprises means such as, the contextualization engine 404 to update the one or more data models with the asset model for instance, in the model store 402. Additionally, at step 612 of exemplary flowchart 600, the asset modelling system 400 comprises means such as, the user interface engine 406 to generate one or more dashboards based on the one or more updated data models. Also, at step 614 of exemplary flowchart 600, the asset modelling system 400 comprises means such as, the contextualization engine 404 to control one or more operations associated with the one or more assets based at least on the one or more updated data models.

FIG. 7 illustrates a flowchart showing a method described in accordance with one or more example embodiments described herein. The exemplary flowchart 700 described herein is implementable via the asset modelling system 400 described in accordance with FIG. 4 of current disclosure. At step 702 of exemplary flowchart 700, the asset modelling system 400 comprises means such as, the user interface engine 406 to render on a user interface, one or more dashboards associated with one or more assets in a facility. Then, at step 704 of exemplary flowchart 700, the asset modelling system 400 comprises means such as, the contextualization engine 404 to analyze a pattern of usage associated with each of the one or more dashboards. Additionally, at step 706 of exemplary flowchart 700, the asset modelling system 400 comprises means such as, the user interface engine 406 to render on the user interface, one or more updated dashboards based at on the pattern of usage.

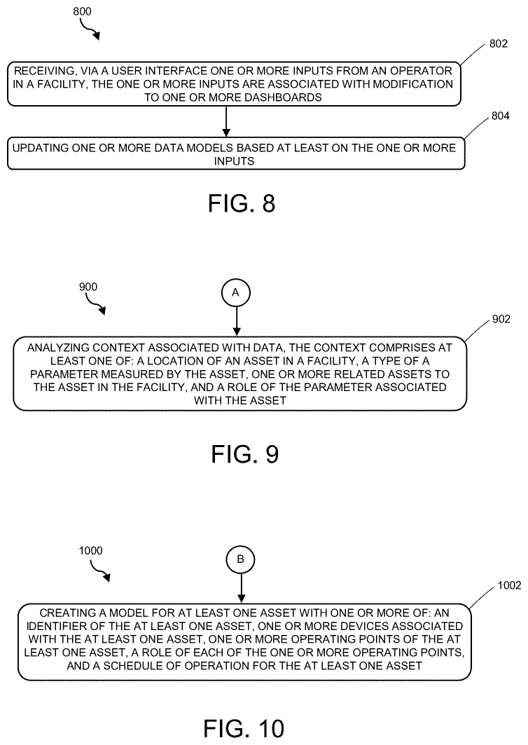

FIG. 8 illustrates a flowchart showing a method described in accordance with one or more example embodiments described herein. The exemplary flowchart 800 described herein is implementable via the asset modelling system 400 described in accordance with FIG. 4 of current disclosure. At step 802 of exemplary flowchart 800, the asset modelling system 400 comprises means such as, the user interface engine 406 to receive via a user interface one or more inputs from an operator in a facility. In this regard, the one or more inputs are associated with modification to one or more dashboards. Then, at step 804 of exemplary flowchart 800, the asset modelling system 400 comprises means such as, the contextualization engine 404 to update one or more data models based at least on the one or more inputs.

FIG. 9 illustrates a flowchart showing a method described in accordance with one or more example embodiments described herein. The exemplary flowchart 900 described herein is implementable via the asset modelling system 400 described in accordance with FIG. 4 of current disclosure. At step 902 of exemplary flowchart 900, the asset modelling system 400 comprises means such as, the contextualization engine 404 to analyze context associated with data received at the contextualization engine 404. In this regard, the context comprises at least one of: a location of an asset in a facility, a type of a parameter measured by the asset, one or more related assets to the asset in the facility, and a role of the parameter associated with the asset.

FIG. 10 illustrates a flowchart showing a method described in accordance with one or more example embodiments described herein. The exemplary flowchart 1000 described herein is implementable via the asset modelling system 400 described in accordance with FIG. 4 of current disclosure. At step 1002 of exemplary flowchart 1000, the asset modelling system 400 comprises means such as, the contextualization engine 404 to create a model for at least one asset with one or more of: an identifier of the at least one asset, one or more devices associated with the at least one asset, one or more operating points of the at least one asset, a role of each of the one or more operating points, and a schedule of operation for the at least one asset, as a part of generation of one or more asset models.

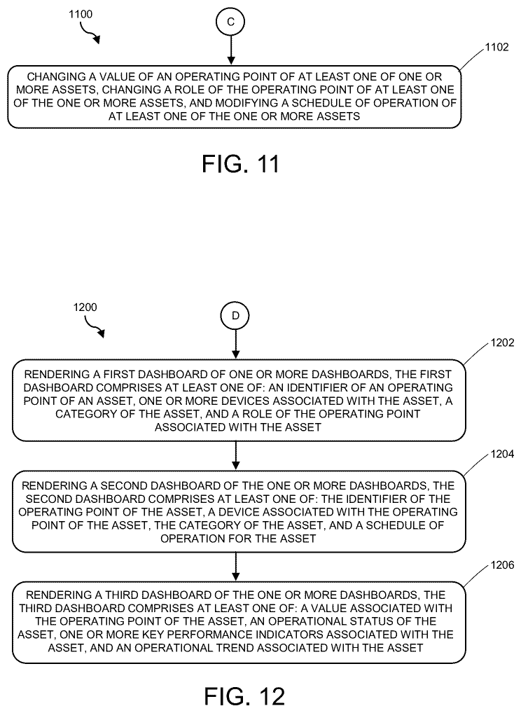

FIG. 11 illustrates a flowchart showing a method described in accordance with one or more example embodiments described herein. The exemplary flowchart 1100 described herein is implementable via the asset modelling system 400 described in accordance with FIG. 4 of current disclosure. At step 1102 of exemplary flowchart 1100, the asset modelling system 400 comprises means such as, the contextualization engine 404 to change a value of an operating point of at least one of one or more assets, changing a role of the operating point of at least one of the one or more assets, and modifying a schedule of operation of at least one of the one or more assets in view of controlling the one or more assets in a facility.

FIG. 12 illustrates a flowchart showing a method described in accordance with one or more example embodiments described herein. The exemplary flowchart 1200 described herein is implementable via the asset modelling system 400 described in accordance with FIG. 4 of current disclosure. At step 1202 of exemplary flowchart 1200, the asset modelling system 400 comprises means such as, the user interface engine 406 to render a first dashboard of one or more dashboards via a display of a computing device. In this regard, the first dashboard comprises at least one of: an identifier of an operating point of an asset, one or more devices associated with the asset, a category of the asset, and a role of the operating point associated with the asset. Then, at step 1204 of exemplary flowchart 1200, the asset modelling system 400 comprises means such as, the user interface engine 406 to render a second dashboard of the one or more dashboards via a display of a computing device. In this regard, the second dashboard comprises at least one of: the identifier of the operating point of the asset, a device associated with the operating point of the asset, the category of the asset, and a schedule of operation for the asset. Further, at step 1206 of exemplary flowchart 1200, the asset modelling system 400 comprises means such as, the user interface engine 406 to render a third dashboard of the one or more dashboards via a display of a computing device. In this regard, the third dashboard comprises at least one of: a value associated with the operating point of the asset, an operational status of the asset, one or more key performance indicators associated with the asset, and an operational trend associated with the asset.

The foregoing embodiments are provided merely as illustrative examples and are not intended to require or imply that the steps of the various embodiments must be performed in the order presented. As will be appreciated by one of skill in the art the order of steps in the foregoing embodiments can be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

It is to be appreciated that ‘one or more’ includes a function being performed by one element, a function being performed by more than one element, e.g., in a distributed fashion, several functions being performed by one element, several functions being performed by several elements, or any combination of the above.

Moreover, it will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

The systems, apparatuses, devices, and methods disclosed herein are described in detail by way of examples and with reference to the figures. The examples discussed herein are examples only and are provided to assist in the explanation of the apparatuses, devices, systems, and methods described herein. None of the features or components shown in the drawings or discussed below should be taken as mandatory for any specific implementation of any of these the apparatuses, devices, systems or methods unless specifically designated as mandatory. For ease of reading and clarity, certain components, modules, or methods may be described solely in connection with a specific figure. In this disclosure, any identification of specific techniques, arrangements, etc. are either related to a specific example presented or are merely a general description of such a technique, arrangement, etc. Identifications of specific details or examples are not intended to be, and should not be, construed as mandatory or limiting unless specifically designated as such. Any failure to specifically describe a combination or sub-combination of components should not be understood as an indication that any combination or sub-combination is not possible. It will be appreciated that modifications to disclosed and described examples, arrangements, configurations, components, elements, apparatuses, devices, systems, methods, etc. can be made and may be desired for a specific application. Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

Throughout this disclosure, references to components or modules generally refer to items that logically can be grouped together to perform a function or group of related functions. Like reference numerals are generally intended to refer to the same or similar components. Components and modules can be implemented in software, hardware, or a combination of software and hardware. The term “software” is used expansively to include not only executable code, for example machine-executable or machine-interpretable instructions, but also data structures, data stores and computing instructions stored in any suitable electronic format, including firmware, and embedded software. The terms “information” and “data” are used expansively and includes a wide variety of electronic information, including executable code; content such as text, video data, and audio data, among others; and various codes or flags. The terms “information,” “data,” and “content” are sometimes used interchangeably when permitted by context.

The hardware used to implement the various illustrative logics, logical blocks, modules, and circuits described in connection with the aspects disclosed herein can include a general purpose processor, a digital signal processor (DSP), a special-purpose processor such as an application specific integrated circuit (ASIC) or a field programmable gate array (FPGA), a programmable logic device, discrete gate or transistor logic, discrete hardware components, or any combination thereof designed to perform the functions described herein. A general-purpose processor can be a microprocessor, but, in the alternative, the processor can be any processor, controller, microcontroller, or state machine. A processor can also be implemented as a combination of computing devices, e.g., a combination of a DSP and a microprocessor, a plurality of microprocessors, one or more microprocessors in conjunction with a DSP core, or any other such configuration. Alternatively, or in addition, some steps or methods can be performed by circuitry that is specific to a given function.

In one or more example embodiments, the functions described herein can be implemented by special-purpose hardware or a combination of hardware programmed by firmware or other software. In implementations relying on firmware or other software, the functions can be performed as a result of execution of one or more instructions stored on one or more non-transitory computer-readable media and/or one or more non-transitory processor-readable media. These instructions can be embodied by one or more processor-executable software modules that reside on the one or more non-transitory computer-readable or processor-readable storage media. Non-transitory computer-readable or processor-readable storage media can in this regard comprise any storage media that can be accessed by a computer or a processor. By way of example but not limitation, such non-transitory computer-readable or processor-readable media can include random access memory (RAM), read-only memory (ROM), electrically erasable programmable read-only memory (EEPROM), FLASH memory, disk storage, magnetic storage devices, or the like. Disk storage, as used herein, includes compact disc (CD), laser disc, optical disc, digital versatile disc (DVD), floppy disk, and Blu-ray Disc™, or other storage devices that store data magnetically or optically with lasers. Combinations of the above types of media are also included within the scope of the terms non-transitory computer-readable and processor-readable media. Additionally, any combination of instructions stored on the one or more non-transitory processor-readable or computer-readable media can be referred to herein as a computer program product.

Many modifications and other embodiments of the inventions set forth herein will come to mind to one skilled in the art to which these inventions pertain having the benefit of teachings presented in the foregoing descriptions and the associated drawings. Although the figures only show certain components of the apparatus and systems described herein, it is understood that various other components can be used in conjunction with the supply management system. Therefore, it is to be understood that the inventions are not to be limited to the specific embodiments disclosed and that modifications and other embodiments are intended to be included within the scope of the appended claims. Moreover, the steps in the method described above can not necessarily occur in the order depicted in the accompanying diagrams, and in some cases one or more of the steps depicted can occur substantially simultaneously, or additional steps can be involved. Although specific terms are employed herein, they are used in a generic and descriptive sense only and not for purposes of limitation.

It is intended that the specification and examples be considered as exemplary only, with a true scope and spirit of the disclosure being indicated by the following claims.

1. A method for modelling one or more assets in a facility, the method comprising:
receiving data associated with the one or more assets in the facility;
retrieving one or more data models associated with the one or more assets;
contextualizing the data based at least on the one or more data models;
generating an asset model for at least one asset of the one or more assets based at least on the contextualized data;
updating the one or more data models with the asset model;
generating one or more dashboards based on the one or more updated data models; and
controlling one or more operations associated with the one or more assets based at least on the one or more updated data models.

2. The method of claim 1, further comprising:
rendering on a user interface, the one or more dashboards associated with the one or more assets in the facility;
analyzing a pattern of usage associated with each of the one or more dashboards; and
rendering on the user interface, one or more updated dashboards based at on the pattern of usage.

3. The method of claim 2, wherein rendering on the user interface, the one or more dashboards comprises:
rendering a first dashboard of the one or more dashboards, wherein the first dashboard comprises at least one of: an identifier of an operating point of an asset, one or more devices associated with the asset, a category of the asset, and a role of the operating point associated with the asset;
rendering a second dashboard of the one or more dashboards, wherein the second dashboard comprises at least one of: the identifier of the operating point of the asset, a device associated with the operating point of the asset, the category of the asset, and a schedule of operation for the asset; and
rendering a third dashboard of the one or more dashboards, wherein the third dashboard comprises at least one of: a value associated with the operating point of the asset, an operational status of the asset, one or more key performance indicators associated with the asset, and an operational trend associated with the asset.

4. The method of claim 1, further comprising:
receiving, via a user interface one or more inputs from an operator in the facility, wherein the one or more inputs are associated with modification to the one or more dashboards; and
updating the one or more data models based at least on the one or more inputs.

5. The method of claim 1, wherein contextualizing the data based at least on the one or more data models comprises:
analyzing context associated with the data, wherein the context comprises at least one of: a location of an asset in the facility, a type of a parameter measured by the asset, one or more related assets to the asset in the facility, and a role of the parameter associated with the asset.

6. The method of claim 1, wherein generating the asset model for the at least one asset comprises:
creating a model for the at least one asset with one or more of: an identifier of the at least one asset, one or more devices associated with the at least one asset, one or more operating points of the at least one asset, a role of each of the one or more operating points, and a schedule of operation for the at least one asset.

7. The method of claim 1, wherein controlling the one or more operations associated with the one or more assets comprises at least one of:
changing a value of an operating point of at least one of the one or more assets, changing a role of the operating point of at least one of the one or more assets, and modifying a schedule of operation of at least one of the one or more assets.

8. A system for modelling one or more assets in a facility, the system comprising:
a processor;
a memory communicatively coupled to the processor, wherein the memory comprises one or more instructions which when executed by the processor, cause the processor to:
receive data associated with the one or more assets in the facility;
retrieve one or more data models associated with the one or more assets;
contextualize the data based at least on the one or more data models;
generate an asset model for at least one asset of the one or more assets based at least on the contextualized data;
update the one or more data models with the asset model;
generate one or more dashboards based on the one or more updated data models; and
control one or more operations associated with the one or more assets based at least on the one or more updated data models.

9. The system of claim 8, wherein the processor is further configured to:
render on a user interface, the one or more dashboards associated with the one or more assets in the facility;
analyze a pattern of usage associated with each of the one or more dashboards; and
render on the user interface, one or more updated dashboards based at on the pattern of usage.

10. The system of claim 9, wherein the processor is further configured to:
render a first dashboard of the one or more dashboards, wherein the first dashboard comprises at least one of: an identifier of an operating point of an asset, one or more devices associated with the asset, a category of the asset, and a role of the operating point associated with the asset;
render a second dashboard of the one or more dashboards, wherein the second dashboard comprises at least one of: the identifier of the operating point of the asset, a device associated with the operating point of the asset, the category of the asset, and a schedule of operation for the asset; and
render a third dashboard of the one or more dashboards, wherein the third dashboard comprises at least one of: a value associated with the operating point of the asset, an operational status of the asset, one or more key performance indicators associated with the asset, and an operational trend associated with the asset.

11. The system of claim 8, wherein the processor is further configured to:
receive, via a user interface one or more inputs from an operator in the facility, wherein the one or more inputs are associated with modification to the one or more dashboards; and
update the one or more data models based at least on the one or more inputs.

12. The system of claim 8, wherein the processor is further configured to:
analyze context associated with the data, wherein the context comprises at least one of: a location of an asset in the facility, a type of a parameter measured by the asset, one or more related assets to the asset in the facility, and a role of the parameter associated with the asset; and
create a model for the at least one asset with one or more of: an identifier of the at least one asset, one or more devices associated with the at least one asset, one or more operating points of the at least one asset, a role of each of the one or more operating points, and a schedule of operation for the at least one asset.

13. The system of claim 8, wherein the processor is further configured to:
change a value of an operating point of at least one of the one or more assets, changing a role of the operating point of at least one of the one or more assets, and modifying a schedule of operation of at least one of the one or more assets.

14. A non-transitory, computer-readable storage medium having stored thereon executable instructions that, when executed by one or more processors, cause the one or more processors to:
receive data associated with one or more assets in a facility;
retrieve one or more data models associated with the one or more assets;
contextualize the data based at least on the one or more data models;
generate an asset model for at least one asset of the one or more assets based at least on the contextualized data;
update the one or more data models with the asset model;
generate one or more dashboards based on the one or more updated data models; and
control one or more operations associated with the one or more assets based at least on the one or more updated data models.

15. The non-transitory, computer-readable storage medium of claim 14, wherein the one or more processors is further configured to:
render on a user interface, the one or more dashboards associated with the one or more assets in the facility;
analyze a pattern of usage associated with each of the one or more dashboards; and
render on the user interface, one or more updated dashboards based at on the pattern of usage.

16. The non-transitory, computer-readable storage medium of claim 15, wherein the one or more processors is further configured to:
render a first dashboard of the one or more dashboards, wherein the first dashboard comprises at least one of: an identifier of an operating point of an asset, one or more devices associated with the asset, a category of the asset, and a role of the operating point associated with the asset;
render a second dashboard of the one or more dashboards, wherein the second dashboard comprises at least one of: the identifier of the operating point of the asset, a device associated with the operating point of the asset, the category of the asset, and a schedule of operation for the asset; and
render a third dashboard of the one or more dashboards, wherein the third dashboard comprises at least one of: a value associated with the operating point of the asset, an operational status of the asset, one or more key performance indicators associated with the asset, and an operational trend associated with the asset.

17. The non-transitory, computer-readable storage medium of claim 14, wherein the one or more processors is further configured to:
receive, via a user interface one or more inputs from an operator in the facility, wherein the one or more inputs are associated with modification to the one or more dashboards; and
update the one or more data models based at least on the one or more inputs.

18. The non-transitory, computer-readable storage medium of claim 14, wherein the one or more processors is further configured to:
analyze context associated with the data, wherein the context comprises at least one of: a location of an asset in the facility, a type of a parameter measured by the asset, one or more related assets to the asset in the facility, and a role of the parameter associated with the asset.

19. The non-transitory, computer-readable storage medium of claim 14, wherein the one or more processors is further configured to:
create a model for the at least one asset with one or more of: an identifier of the at least one asset, one or more devices associated with the at least one asset, one or more operating points of the at least one asset, a role of each of the one or more operating points, and a schedule of operation for the at least one asset.

20. The non-transitory, computer-readable storage medium of claim 14, wherein the one or more processors is further configured to:
change a value of an operating point of at least one of the one or more assets, changing a role of the operating point of at least one of the one or more assets, and modifying a schedule of operation of at least one of the one or more assets.
